(19) United States
(12) Patent Application Publication
(10) Pub. No.: US 2009/0122438 A1
(43) Pub. Date: May 14, 2009

(54) DESIGN OF FEEDFORWARD CONTROLLER FOR CONTROLLING POSITION OF MAGNETIC HEAD IN MAGNETIC DISK DRIVE

(75) Inventors: Takuji Matsuzawa, Kawasaki (JP); Shinji Koganezawa, Kawasaki (JP); Takeyori Hara, Kawasaki (JP); Kei Funabashi, Kawasaki (JP); Shinichi Ohtsuka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/204,657

(22) Filed: Sep. 4, 2008

(30) Foreign Application Priority Data
Nov. 13, 2007 (JP) 2007-294865

(51) Int. Cl. G11B 21/02

(52) U.S. Cl. 360/75; G9B/21.003

(57) ABSTRACT

For a feedforward controller for controlling a position of a magnetic head in a magnetic disk drive, a vibration of the magnetic head is measured in a state in which a magnetic disk is rotated in the magnetic disk drive. From a spectrum of the measured vibration, a flutter frequency which is a frequency of a vibration caused by the magnetic disk fluttering is obtained. A filter is designed for each flutter frequency having a peak of a gain for a respective one of obtained flutter frequencies. The feedforward controller for controlling a position of the magnetic head is obtained by combining filters designed for the respective flutter frequencies.

### CROSS-REFERENCE TO RELATED APPLICATIONS

This application is based upon and claims the benefit of priority of the prior Japanese Patent Application No. 2007-294865, filed on Nov. 13, 2007, the entire contents of which are incorporated herein by reference.

### FIELD

The embodiment discussed herein is directed to a designing method for a feedforward controller controlling a magnetic head in a magnetic disk drive, a magnetic disk drive having a feedforward controller designed in the designing method and a feedforward controller designed in the designing method.

### BACKGROUND

High precision is required for controlling a position of a magnetic head which should follow a predetermined track on a magnetic disk, along with increase in a recording density in a magnetic disk drive.

In the situation, a vibration perpendicular to a disk plane of a magnetic disk itself caused to rotation of the magnetic disk, which is a disturbance, may adversely affect precision in the above-mentioned control of a position of the magnetic head. Such a sort of a vibration is referred to as disk flutter.

In order to reduce an influence of disk flutter to a position error which may occur in the control of a position of the magnetic head, the following method has been proposed (see Japanese Laid-Open Patent Application No. 2003-217244 and U.S. Pat. Nos. 6,771,454 and 6,888,694). That is, in addition to ordinary feedback (simply referred to as FB, hereinafter) control, feedforward (simply referred to as FF, hereinafter) control is carried out with detection of a vibration with the use of a vibration sensor made of a piezoelectric device, a capacity sensor or such, which may be provided to a suspension or an arm which supports the magnetic head or to a housing of the magnetic disk drive.

In the above-mentioned prior art, a single FF controller is provided to a magnetic disk drive. Therefore, in a magnetic disk drive having a plurality of magnetic disks, control considering modes of disk flutter having different frequencies or gains depending on respective magnetic disks may not be achieved.

Vibration sensors may be mounted to respective ones of all the suspensions or arms, and control may be made in such a manner that a position of each magnetic head is controlled with the use of an output of a vibration sensor provided to the suspension or the arm on which each magnetic head is mounted. However, in such a configuration, the number of vibration sensors are required, which number corresponds to the number of magnetic heads, and also, amplifiers for amplifying outputs of the vibration sensors are required corresponding to the number of vibration sensors. Thus, product costs increase.

FIG. 1 is a front view diagrammatically illustrating positional relationship between magnetic disks, magnetic heads and vibration sensors in one example of the related art.

In the example of FIG. 1, the vibration sensors are provided to all the suspensions or arms to detect disk flutter, and control is made for positions of all the magnetic heads with the use of a single FF controller with the use of outputs of the vibration sensors. In such a magnetic disk drive having a plurality of magnetic disks, as shown in FIG. 1, modes of disk flutter having different frequencies depending on respective magnetic disks may occur. Therefore, sufficient control may not be achieved with a single common FF controller for all of the plurality of magnetic disks. Modes of disk flutter are discussed in, for example, U.S. Pat. No. 7,012,777 (referred to as a fifth patent document, later), G. Ferretti et al., “Modeling and Experimental Analysis of the Vibrations in Hard Disk Drives”, IEEE Trans. Magn., Vol. 7, No. 2, June 2002, and L. Guo et al., “Disk Flutter and Its Impact on HDD Servo Performance”, IEEE Trans., Magn., Vol. 37, No. 2, March, 2001 (referred to as a second non-patent document, later).

Further, in order to reduce the influence of a disturbance to precision of a magnetic head caused by disk flutter, vibration sensors may be provided to all of suspensions or arms as mentioned above. However, in such a configuration, as mentioned above, the number of vibration sensors, as well as the number of amplifiers amplifying outputs of the vibration sensors, may increase, and thus, a problem of costs may occur.

Japanese Laid-Open Patent Application No. 2006-107708 also discloses the related art.

### SUMMARY

In the embodiment, a vibration of a magnetic head is measured in a state in which a magnetic disk is rotated in a magnetic disk drive. From a spectrum of measured vibration, a flutter frequency which is a frequency of a vibration caused by disk flutter is obtained. A filter is designed for each flutter frequency having a peak of a gain for each flutter frequency. FF controller for controlling a position of the magnetic head is obtained by combining filters thus designed for the respective flutter frequencies.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 illustrates a configuration of the related art;

FIG. 2 is a plan view of a magnetic disk drive in the embodiment;

FIG. 3 is a block diagram of a control system of the magnetic disk drive depicted in FIG. 2;

FIG. 4 is a block diagram of a control system for magnetic head positioning control in the magnetic disk drive depicted in FIG. 2;

FIG. 5 is a plan view diagrammatically depicting mounting positions of magnetic heads and vibration sensors used for FF control in one example in the magnetic disk drive depicted in FIG. 2;

FIG. 6 is a plan view diagrammatically depicting mounting positions of magnetic heads and vibration sensors used for FF control in another example in the magnetic disk drive depicted in FIG. 2;

FIG. 7 illustrates a frequency response of a FF controller depicted in FIG. 4;

FIG. 8 illustrates a position error signal;

FIG. 9 illustrates an output signal of a vibration sensor;

FIG. 10 illustrates a configuration of filters included in the FF controller in the control system depicted in FIG. 4;

FIG. 11 is a flow chart illustrating a method of designing the FF controller in the control system depicted in FIG. 4;

FIG. 12 depicts an example of a frequency response of the FF controller, for illustrating the method of designing the FF controller in the control system depicted in FIG. 4;

FIG. 13 depicts an example of a spectrum of a position error signal (PES), for illustrating the method of designing the FF controller in the control system depicted in FIG. 4;

FIG. 14 depicts an example of frequency responses of filters included in the FF controller, for illustrating the method of designing the FF controller in the control system depicted in FIG. 4;

FIG. 15 illustrates advantages of FF control carried out by the FF controller in the control system depicted in FIG. 4;

FIG. 16 diagrammatically depicts an example of a configuration used for measuring disk flutter, for illustrating the method of designing the FF controller in the control system depicted in FIG. 4;

FIG. 17 depicts an example of a spectrum of a vertical vibration of a magnetic disk, for illustrating the method of designing the FF controller in the control system depicted in FIG. 4;

FIG. 18 depicts an example of a spectrum of an output of a vibration sensor, for illustrating the method of designing the FF controller in the control system depicted in FIG. 4;

FIG. 19 depicts an example of a spectrum of a position error signal (PES), for illustrating the method of designing the FF controller in the control system depicted in FIG. 4;

FIG. 20 is a block diagram of a part of the control system depicted in FIG. 4;

FIG. 21 illustrates a relationship between disk flutter and a position error;

FIGS. 22 and 23 illustrate a method of adjusting frequency responses of filters, in the method of designing the FF controller in the control system depicted in FIG. 4;

FIG. 24 illustrates gain and phase requirements for a frequency of a flutter component, for illustrating the method of designing the FF controller in the control system depicted in FIG. 4;

FIG. 25 illustrates gain and phase requirements for minimizing an influence of disk flutter, for illustrating the method of designing the FF controller in the control system depicted in FIG. 4;

FIG. 26 illustrates gain and phase requirements for frequencies other than the flutter components, for illustrating the method of designing the FF controller in the control system depicted in FIG. 4; and

FIG. 27 is a perspective view of one example of a head stuck assembly including an actuator arm assembly and a magnetic circuit.

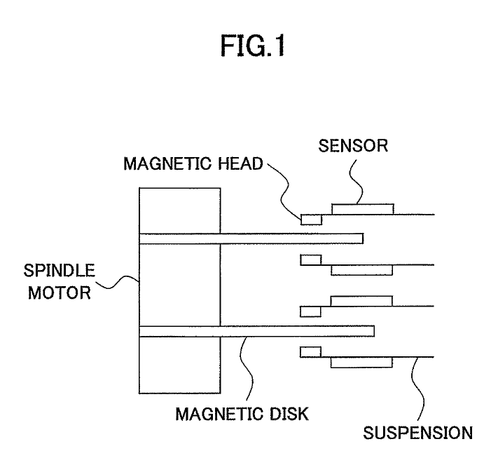

### DESCRIPTION OF REFERENCE NUMERALS

10, 11, 12 FF CONTROLLER
20 FB CONTROLLER
50-1, 50-2 VIBRATION SENSOR
110, 110-1, 110-2 MAGNETIC DISK
120 SPINDLE MOTOR
130, 130-1 through 130-4 MAGNETIC HEAD
145 SUSPENSION
160 VOICE COIL MOTOR
SW1, SW2, SW3 SWITCH

### DESCRIPTION OF EMBODIMENT

According to a method of designing a FF controller in the embodiment, a FF controller is provided in which an influence of disk flutter of a magnetic disk is considered, and precision in control of a position of a magnetic head in a magnetic disk drive can be improved.

In the method, a vibration of a magnetic disk is measured with the magnetic disk being rotated in a magnetic disk drive. From a spectrum of thus-measured vibration of the magnetic disk, a flutter frequency which is a frequency of a vibration caused by disk flutter is obtained. A filter is provided for each flutter frequency, the filter having a peak of a gain at each flutter frequency. Thus-provided filters for the respective flutter frequencies are combined together, and thus, a FF controller for controlling a position of a magnetic head is provided. Control for controlling a position of a magnetic head may be referred to as a magnetic head positioning control.

In the embodiment, as mentioned above, measured data of vibrations obtained from actual rotation of the magnetic disk is used to obtain the filters. Thus, in the embodiment, the flutter frequencies which are frequencies of disk flutter unique to each magnetic disk are obtained, and the filters are obtained each having a peak of a gain for a respective one of the flutter frequencies. The thus-obtained filters for the respective flutter frequencies are combined together to obtain the FF controller for controlling a position of the magnetic disk. Therefore, it is possible to provide the FF controller having performance suitable to the disk flutter unique to each magnetic disk. Therefore, the thus-obtained FF controller can carry out magnetic head positioning control with an effectively improved precision, in consideration with an influence of the disk flutter of the magnetic disk.

With reference to drawings, the embodiment of the present invention will be described in detail.

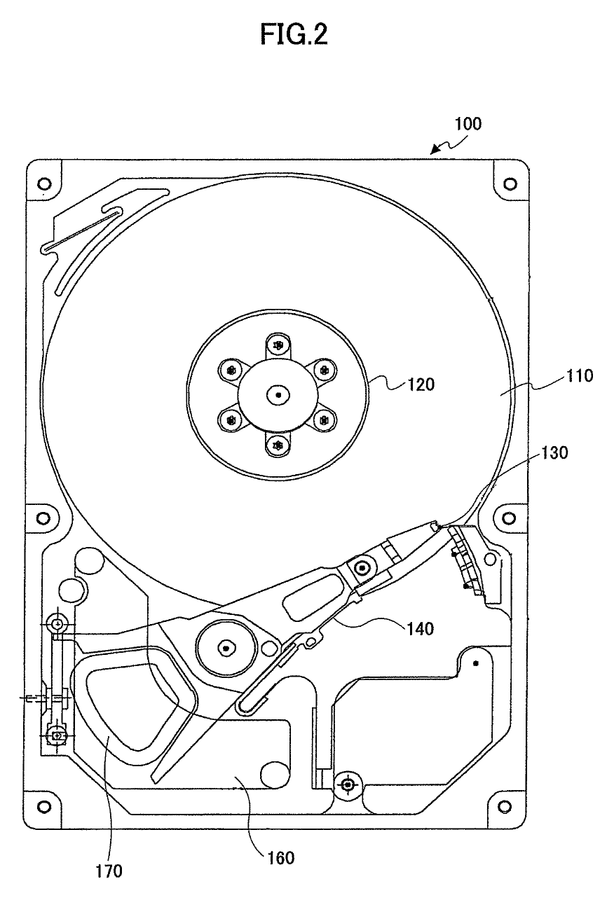

FIG. 2 depicts a general configuration of a hard disk drive as a magnetic disk drive in the embodiment of the present invention.

As depicted in FIG. 2, the hard disk drive includes magnetic disks 110, a spindle motor 120 configured to drive and rotate the magnetic disks 110, and magnetic heads 130 configured to write information to the magnetic disks 110, or read information from the magnetic disks 110. The hard disk drive further includes an actuator arm assembly 140 which moves the magnetic heads 130 in a radius direction of the magnetic disks 110 as a result of arms rotating, and a VCM (voice coil motor) 160 which controls a rotating operation of the actuator arm assembly.

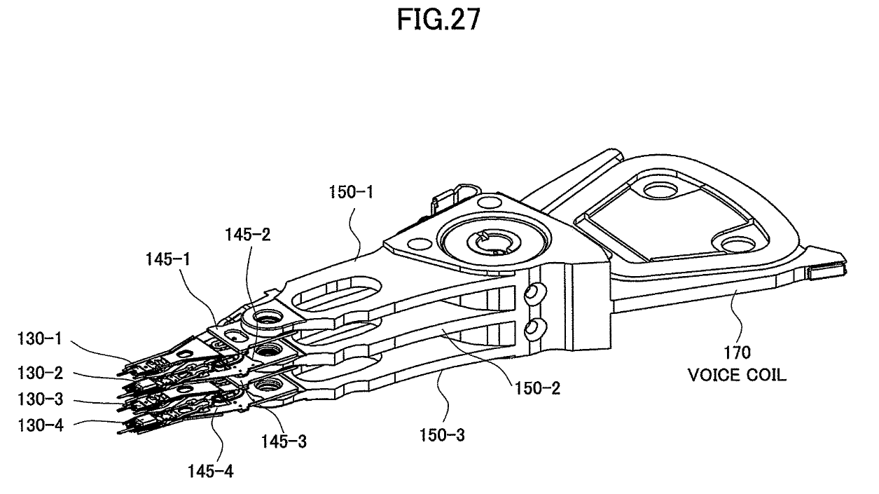

FIG. 27 depicts a perspective view of one example of a head stuck assembly which includes the actuator assembly 140 and the voice coil 170 applicable in the hard disk drive.

The actuator arm assembly includes arms 150-1 through 150-3 (which may be generally referred to as arms 150), suspensions 145-1 through 145-4 (which may be generally referred to as suspensions 145) and magnetic heads 130-1 through 130-4 (which may be generally referred to as arms 130). A suspension 145-1 is mounted on an extending end of the arm 150-1, suspensions 145-2 and 145-3 are mounted on an extending end of the arm 150-2, and a suspension 145-4 is mounted on an extending end of the arm 150-3, as depicted in FIG. 27. The suspensions 145-1 through 145-4 may be generally referred to as suspensions 145. On the suspensions 145-1, 145-2, 145-3 and 145-4, magnetic heads 130-1, 130-2, 130-3 and 130-4 (which may be generally referred to as magnetic heads 130), respectively, are mounted. The actuator arm assembly 140 includes the arms 150 and the suspensions 145.

Head numbers are given as follows: A head 1 is given to a set of the arm 150-1, the suspension 145-1 and the magnetic head 130-1. A head 2 is given to a set of the arm 150-2, the suspension 145-2 and the magnetic head 130-2. A head 3 is given to a set of the arm 150-2, the suspension 145-3 and the magnetic head 130-3. A head 4 is given to a set of the arm 150-3, the suspension 145-4 and the magnetic head 130-4.

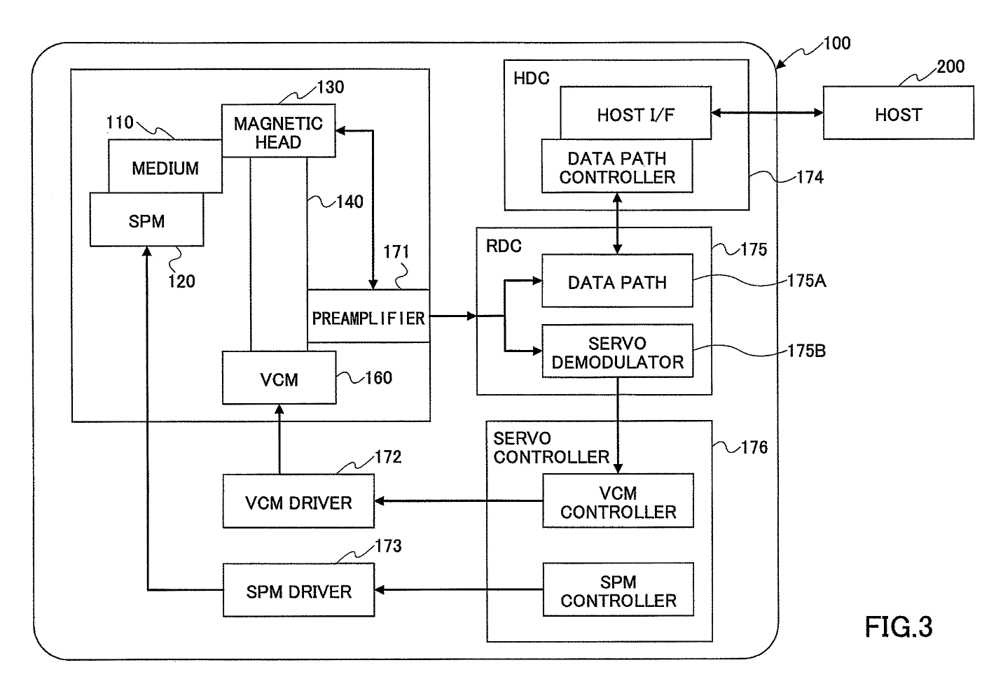

FIG. 3 depicts a block configuration of a control system in the hard disk drive depicted in FIG. 2.

The control system depicted in FIG. 3 includes a preamplifier 171 amplifying signals read from the magnetic disks 110 by means of the magnetic heads 130, and a read channel circuit 175 which processes thus-amplified reproduced signals, separates the signals into servo information and data signals, and transmits the servo information to a servo controller 176 and transmits the data signals to a hard disk controller 174. The control system further includes the hard disk controller 174 which processes the data signals, and transmits the signals to a host apparatus 200. The control system further includes the servo controller 176 which generates a control signal for a VCM driver 172 controlling the actuator arm assembly 140 based on the servo information, and also, generates a control signal for a SPM driver 173 controlling the spindle motor 120 based on the servo information. The control system further includes the VCM driver 172 controlling operation of the actuator arm assembly 140 with the use of a VCM (voice coil motor) 160 based on the control signal. The control system further includes the SPM driver 173 carrying out control of rotation of the magnetic disks 110 with the use of the spindle motor 120.

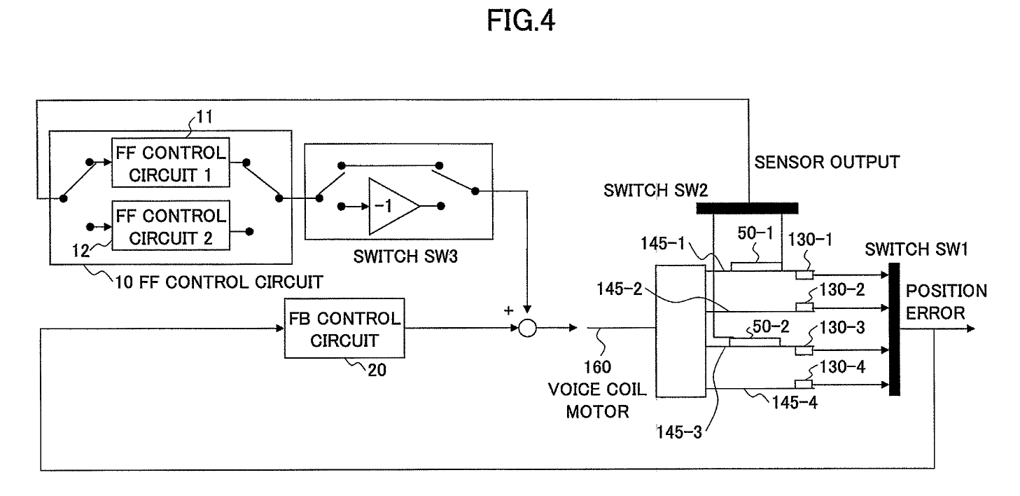

In the configuration depicted in FIG. 3, the VCM controller 172 included in the servo controller 176 acts as a part of the control system to carry out magnetic head positioning control, in the magnetic disk drive. FIG. 4 depicts one example of a block diagram of the part of the control system to carry out magnetic head positioning control in the magnetic disk drive. In FIG. 4, the above-mentioned part of the control system to carry out magnetic head positioning control in the magnetic disk drive includes switches SW1, SW2, a FB controller 20, a FF controller 10, a switch SW3 and the voice coil motor 160. The FF controller 10 includes a FF controller 1, 11, and a FF controller 2, 12.

The suspensions 145-1 and 145-3 have vibration sensors 50-1 and 50-2 (which may be generally referred to as vibration sensors 50, hereinafter), respectively, for detecting disk flutter. It is noted that, as to relationship of the voice coil motor 160, the arms 150, the suspensions 145 and the magnetic heads 130, see also FIG. 27, described above. In the example of FIG. 4, a pair of the magnetic heads 130-1 and 130-2 face both sides of one magnetic disk (not depicted in FIG. 4), respectively, while another pair of the magnetic heads 130-3 and 130-4 face both sides of another magnetic disk (not depicted in FIG. 4), respectively.

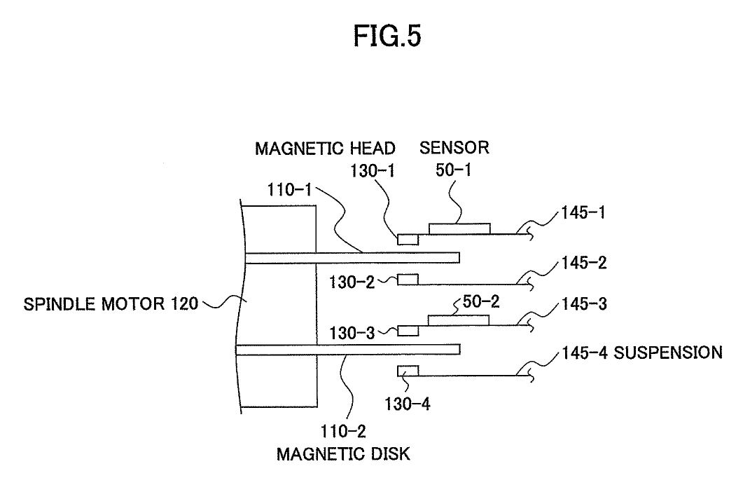

FIG. 5 diagrammatically depicts relationship between the respective magnetic disks, the respective magnetic heads and the respective vibration sensors. As depicted in FIG. 5, as mentioned above, the pair of the magnetic heads 130-1 and 130-2 faces both sides of one magnetic disk 110-1, respectively, while another pair of the magnetic heads 130-3 and 130-4 faces both sides of another magnetic disk 110-2, respectively. The magnetic disks 110-1 and 110-2 may be generally referred to as magnetic disks 110. The vibration sensors 50-1 is mounted on the upper suspension 145-1 (sandwiching the magnetic disk 110-1 together with the lower suspension 145-2) and detects disk flutter of the magnetic disk 110-1. The vibration sensors 50-2 is mounted on the upper suspension 145-3 (sandwiching the magnetic disk 110-2 together with the lower suspension 145-4) and detects disk flutter of the magnetic disk 110-2.

A position error signal of each magnetic head with respect to the magnetic disk which the magnetic head faces is obtained as the servo information mentioned above with reference to FIG. 3. Based on the servo information, the FB controller 20 generates the control signal provided to the voice coil motor 160. As rotation operation of the voice coil motor 160 is controlled by the control signal, the magnetic heads 130-1 through 130-4 mounted on the respective suspensions 145-1 through 145-4 are driven. Thereby the above-mentioned position error is cancelled, and thus, control is carried out such that the magnetic heads facing the respective magnetic disks are appropriately positioned onto predetermined tracks of the magnetic disks.

Further, disk flutter signals obtained from the vibration sensors 50-1 and 50-2 are transmitted to the FF controller 10, and the disk flutter signals add a control amount to an output of the FB controller 20. As a result, such a control signal is provided to the voice coil motor 160 that a position error amount caused by disk flutter of the magnetic disks is considered. Thereby, it is possible to carry out magnetic head positioning control considering an influence of disk flutter of the mantic disks and thus, it is possible to effectively improve precision in magnetic head positioning control.

The switch SW1 is used to select a position error signal obtained based on a position signal obtained from each of the magnetic heads 130-1 through 130-4, and transmits a selected signal to the FB controller 20. The switch SW2 is used to select a disk flutter signal obtained from each of the vibration sensors 50-1 and 50-2, and transmits a selected signal to the FF controller 10. The switch SW3 is used to pass through an output signal of the FF controller 10 as it is when the magnetic head 130-1 or 130-3 (upper one) is selected by the switch SW1, and invert the output signal of the FF controller 10 when the magnetic head 130-2 or 130-4 (lower one) is selected by the switch SW1.

For positioning the magnetic head 130-1 (upper) provided for the magnetic disk 110-1, the switch SW1 selects the position error signal obtained based on the position signal obtained from the magnetic head 130-1, and transmits the selected signal to the FB controller 20. The switch SW2 selects the disk flutter signal from the vibration sensor 50-1 provided for the magnetic disk 110-1, and transmits the selected signal to the FF controller 10. In the FF controller 10, the FF controller 1, 11 provided for the magnetic disk 110-1, is selected. The switch SW3 causes the output of the FF controller 10 to pass through as it is, because the magnetic head 130-1 is the upper magnetic head with respect to the magnetic disk 110-1 (see FIG. 5).

For positioning the magnetic head 130-2 (lower) provided for the magnetic disk 110-1, the switch SW1 selects the position error signal obtained based on the position signal obtained from the magnetic head 130-2, and transmits the selected signal to the FB controller 20. The switch SW2 selects the disk flutter signal from the vibration sensor 50-1 provided for the magnetic disk 110-1, and transmits the selected signal to the FF controller 10. In the FF controller 10, the FF controller 1, 11 provided for the magnetic disk 110-1 is selected. The switch SW3 causes the output of the FF controller 10 to be inverted and outputs the inverted signal, because the magnetic head 130-2 is the lower magnetic head with respect to the magnetic disk 110-1 (see FIG. 5).

Similarly, for positioning the magnetic head 130-3 (upper) provided for the magnetic disk 110-2, the switch SW1 selects the position error signal obtained based on the positional signal obtained from the magnetic head 130-3, and transmits the selected signal to the FB controller 20. The switch SW2 selects the disk flutter signal from the vibration sensor 50-2 provided for the magnetic disk 110-2, and transmits the selected signal to the FF controller 10. In the FF controller 10, the FF controller 2, 12 provided for the magnetic disk 110-2 is selected. The switch SW3 causes the output of the FF controller 10 to pass through as it is, because the magnetic head 130-3 is the upper magnetic head with respect to the magnetic disk 110-2 (see FIG. 5).

For positioning the magnetic head 130-4 (lower) provided for the magnetic disk 110-2, the switch SW1 selects the positioning error signal obtained based on the positional signal obtained from the magnetic head 130-4, and transmits the selected signal to the FB controller 20. The switch SW2 selects the disk flutter signal from the vibration sensor 50-2 provided for the magnetic disk 110-2, and transmits the selected signal to the FF controller 10. In the FF controller 10, the FF controller 2, 12 provided for the magnetic disk 110-2 is selected. The switch SW3 causes the output of the FF controller 10 to be inverted in its sign and outputs the inverted signal, because the magnetic head 130-4 is the lower magnetic head with respect to the magnetic disk 110-2 (see FIG. 5).

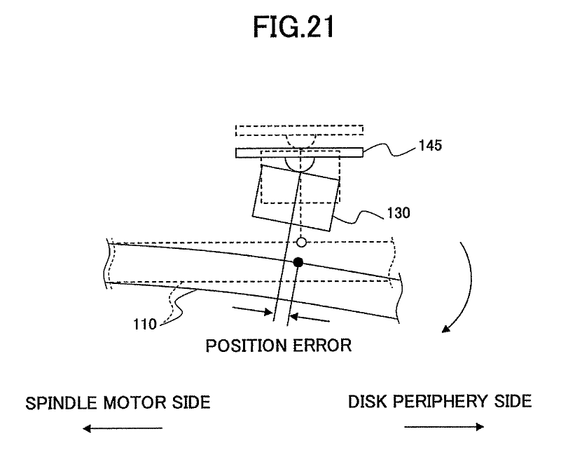

Thus, the sign of the output of the FF controller is inverted between the case of control to position the upper magnetic head with respect to the magnetic disk and the case of control to position the lower magnetic head with respect to the magnetic disk. This is because, as can be seen from a later description made with reference to FIG. 21 concerning an influence of disk flutter on magnetic head positioning control, an influence of disk flutter on magnetic head positioning control is in an opposite direction when a positional relationship of the magnetic head with respect to the magnetic disk is inverted.

In FIG. 3, a VCM controller included in the servo controller 176 acts as the FB controller 20 and the FF controller 10 depicted in FIG. 4. Further, in FIG. 3, the switches SW1, SW2, SW3, and the vibration sensors 50-1, 50-2 shown in FIG. 4 are omitted.

It is possible to suppress an influence of a disturbance to precision of a magnetic head caused by disk flutter more effectively, as a result of, as depicted in FIGS. 4 and 5, the FF controllers 11 and 12 being provided for the respective magnetic disks 110-1 and 110-2, and control being carried out with the use of the FF controller suitable to each magnetic disk which the magnetic heads face.

Further, disk flutter is a vertical vibration of each magnetic disk, and disk flutter detected by the vibration sensor on each suspension or arm which shares the common magnetic disk is different merely by a phase of 180 degrees. In consideration of this matter, as mentioned with reference to FIG. 5, the vibration sensor may be provided only on the suspension or arm on which one of the two magnetic heads which sandwich each magnetic disk is mounted. Then, an output of the vibration sensor may be shared by FF control for the magnetic heads sharing the common magnetic disk. Thereby, it is possible to reduce the number of required vibration sensors and corresponding amplifiers, and thus, it is possible to save cost.

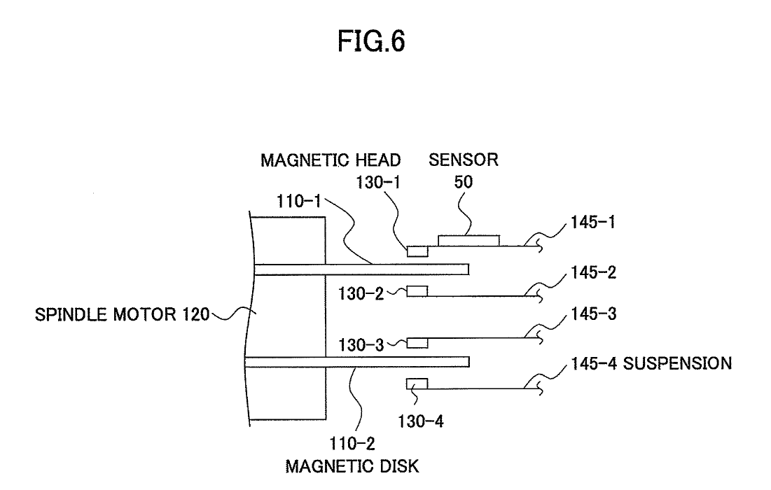

Further alternatively, as shown in FIG. 6, the single common vibration sensor 50 may be provided only on a single suspension or arm in the magnetic disk drive. In this case, an output of the single vibration sensor 50 is used to carry out magnetic head positioning control for all the magnetic heads 130-1 through 130-4. In this case, although performance may somewhat degrade because of an influence of a mode of disk flutter unique to each magnetic disk, it is possible to further reduce the number of required vibration sensors and corresponding amplifiers.

As mentioned above, according to the embodiment, in the magnetic disk drive, the vibration sensors for detecting disk flutter made of a piezoelectric device or such are provided on the suspensions or the arms on which the magnetic heads are mounted. Then, with the use of outputs of the vibration sensors, magnetic head positioning control is carried out. Further, the FF controller is provided for each magnetic disk, and the FF controller suitable to the magnetic disk is used to carry out magnetic head positioning control of each magnetic head which the magnetic disk has.

Further, in this case, as mentioned above, for each magnetic disk, the vibration sensor may be provided only on a suspension or an arm on which any one of the two magnetic heads which sandwich the magnetic disk is mounted. Further, in this case, each of all the vibration sensors may be provided on a suspension or arm on which certain one of upper and lower magnetic heads which sandwich each magnetic disk is mounted, which certain one of upper and lower magnetic heads is of the same side of either an upper side or a lower side of the magnetic head through all the magnetic disks. In this case, upon magnetic head positioning control of the magnetic head which is of the same side as that on which the vibration sensor is provided, FF control may be carried out with the use of an output of the vibration sensor as it is. Upon magnetic head positioning control of the magnetic head which is of the opposite side to that on which the vibration sensor is provided, FF control may be carried out with the use of a signal obtained as a result of the sign being inverted from an output of the vibration sensor which is provided to the other suspension or arm sharing the common magnetic disk.

Alternatively, only the single common vibration sensor may be provided to a single suspension or arm for all of the plurality of magnetic disks, as mentioned above with reference to FIG. 6. In this case, for each magnetic disk, upon magnetic disk positioning control of the upper or lower magnetic head which is of the same side as that on which the vibration sensor is provided, FF control may be carried out with the use of an output of the vibration sensor as it is. Upon magnetic disk positioning control of the upper or lower magnetic head which is of the opposite side to that on which the vibration sensor is provided, FF control may be carried out with the use of a signal obtained as a result of the sign being inverted from an output of the vibration sensor.

Next, a method of designing each of the above-mentioned FF controller 1, 11 and FF controller 2, 12 will be described.

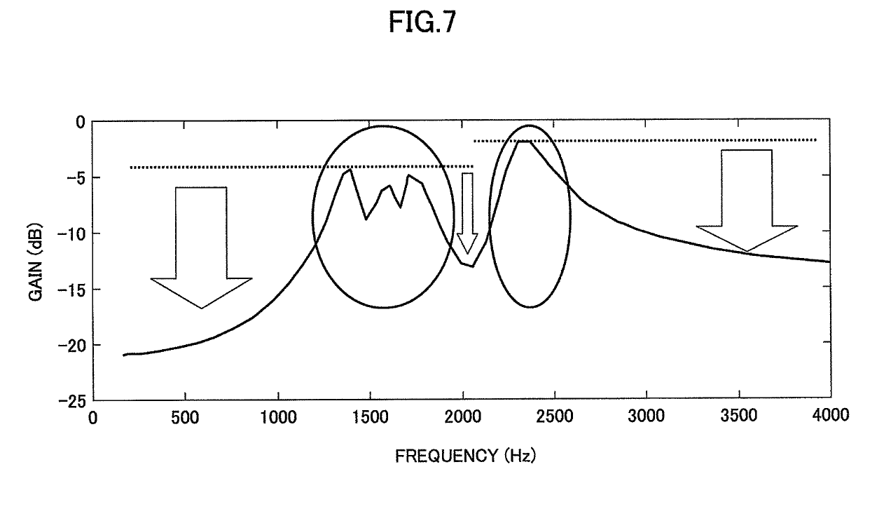

As mentioned above, even in the case where only one vibration sensor 50 is provided for each magnetic disk 110, control performance equivalent to a case where the vibration sensor 50 is provided to each magnetic head 130 is required to be achieved. For this purpose, the FF controller has a frequency response as depicted in FIG. 7.

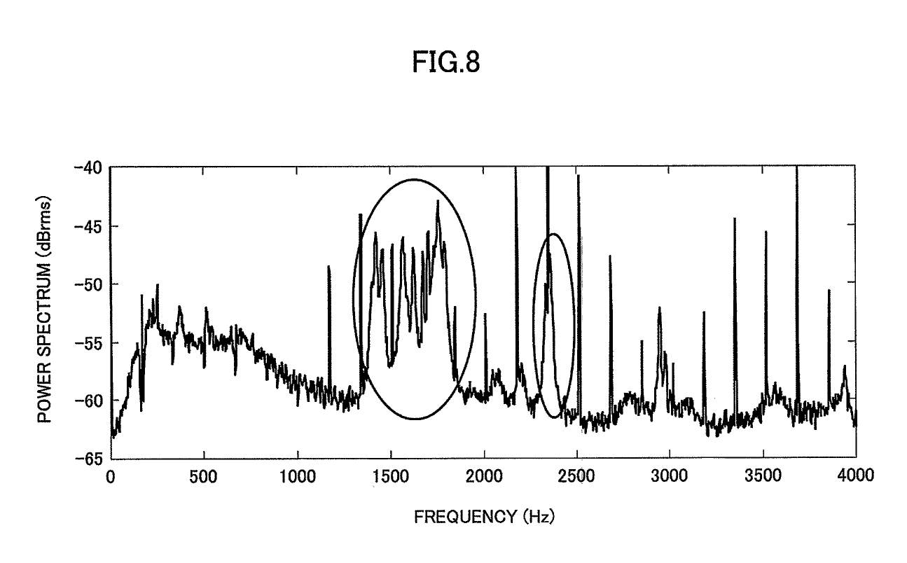

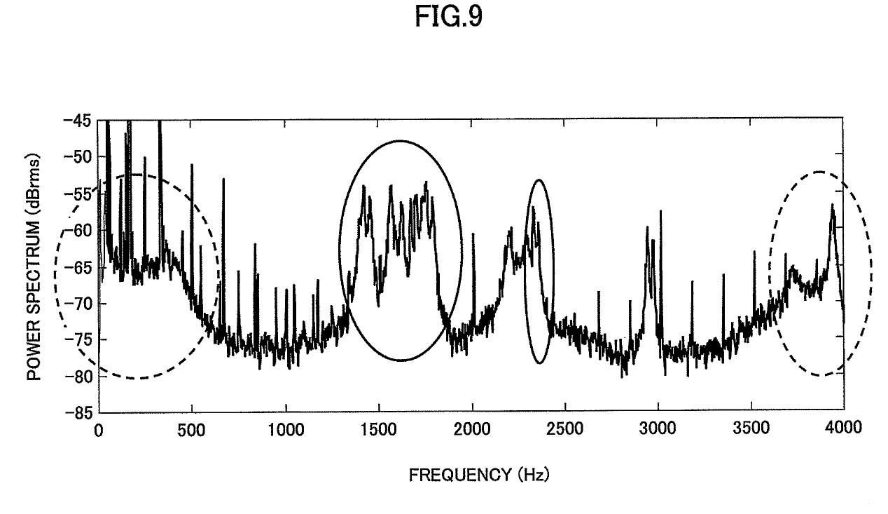

Features of the FF controller are such that, as parts defined by ellipses in FIG. 7, peaks are provided at frequencies around disk flutter frequencies, which can be seen from a position error signal depicted in FIG. 8 and an output of the vibration sensor depicted in FIG. 9. The disk flutter frequencies are those of parts defined by two central ellipses in each of FIGS. 8 and 9, and these frequencies are common between FIGS. 8 and 9. On the other frequencies, as depicted in FIG. 7, a gain is made to be sufficiently lower than a level of a gain on the disk flutter frequencies.

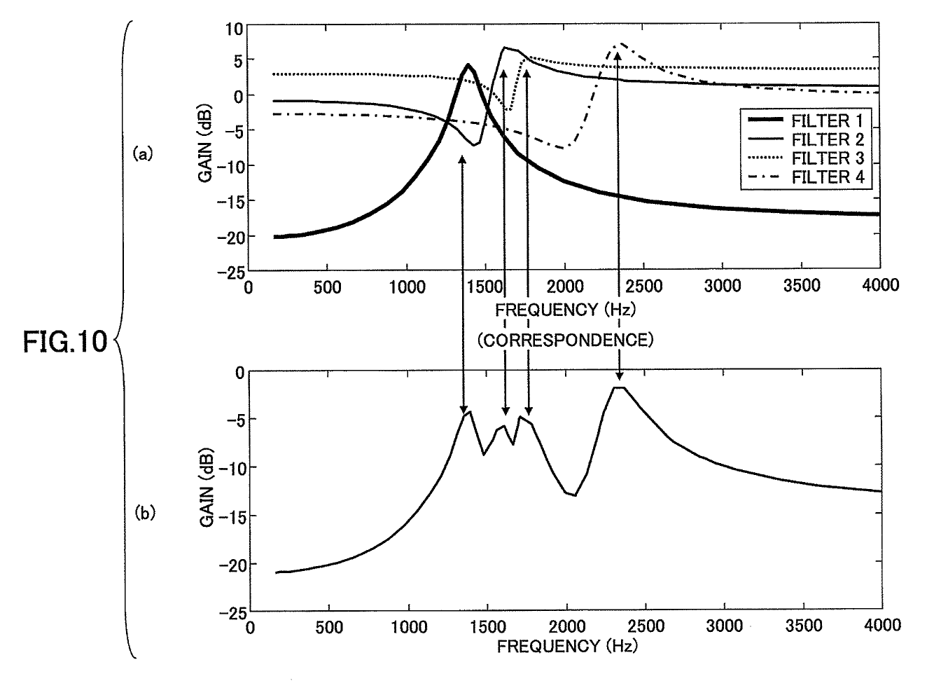

The FF controller having the frequency response depicted in FIG. 7 (the same as those of FIG. 10, (b)) can be obtained in such a configuration that each peak is provided by a respective single second order filter as shown in FIG. 10. In FIG. 10, (a), a frequency response of each of respective single second order filters 1, 2, 3 and 4 is depicted. FIG. 10, (b) depicts a frequency response of a filter obtained from combining the respective single second order filters 1, 2, 3 and 4.

For the magnetic disk drive having the plurality of magnetic disks, disk flutter frequency or gain may vary depending on each magnetic disk. A disk flutter frequency may be simply referred to as a flutter frequency. Therefore, the FF controller is provided for each magnetic disk, and peaks of a gain of each FF controller should agree with flutter frequencies of the corresponding magnetic disk, respectively.

The vibration sensor 50 used in the embodiment is attached to the suspension or arm on which the magnetic head 130 is mounted. Therefore, the vibration sensor 50 may detect also a vibration of the suspension or such which is not directly relevant to disk flutter (see parts defined by ellipses of broken lines at both ends of FIG. 9). Further, the vibration of the suspension or such which is not directly relevant to disk flutter may have a frequency or a gain which varies depending on the above-mentioned head number.

If FF control were carried out with the use of an output of the vibration sensor as it is, magnetic disk positioning control precision would degrade as a whole because of an influence of the above-mentioned vibration not directly relevant to disk flutter which is also detected by the vibration sensor 50. In consideration therewith, the FF controller should have a frequency response as that depicted in FIG. 7, an influence of the vibration of the suspension or such which is not directly relevant to disk flutter which is also detected by the vibration sensor 50 can be eliminated, and thus, a disturbance caused by disk flutter can be effectively suppressed. That is, the frequency response depicted in FIG. 7 is such that, as depicted in FIG. 7, a gain on flutter frequencies corresponding to the parts defined by the ellipses is increased, while, a gain is decreased on the other frequencies indicated by arrows in FIG. 7. Therefore, it is possible to effectively reduce an influence of a vibration not directly relevant to disk flutter.

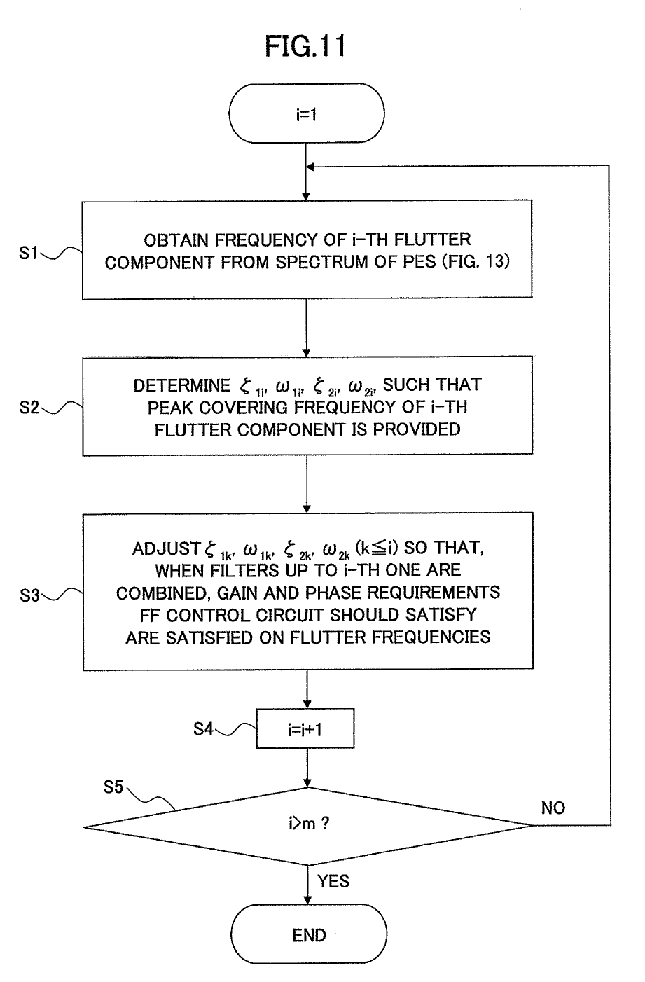

FIG. 11 is a flow chart illustrating a method of designing the FF controller having such a configuration.

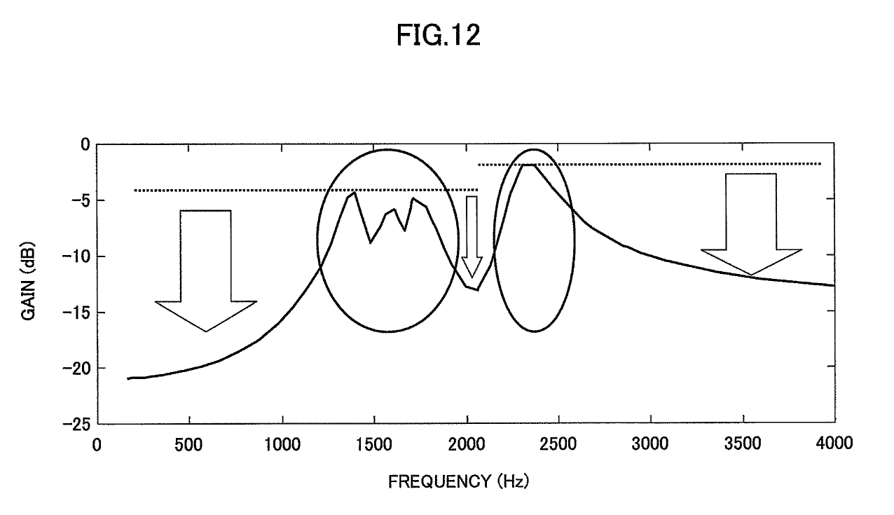

The following formula (1) is one example of a transfer function of the FF controller having a frequency response depicted in FIG. 12 (the same as those of FIG. 7):

$$C ( s ) = {\prod }_{i = 1}^{m} \frac{{s}^{2} + 2 {Ϛ}_{2 i} {ω}_{2 i} s + {ω}_{2 i}^{2}}{{s}^{2} + 2 {Ϛ}_{1 i} {ω}_{1 i} s + {ω}_{1 i}^{2}} \qquad ( 1 )$$

In the embodiment, one peak on a frequency (i.e., a flutter frequency) of a component of each mode of disk flutter (simply referred to as a flutter component, hereinafter) is provided by a single second order filter. Then, as described above with reference to FIG. 10, (a) and (b), the respective single second order filters 1, 2, 3 and 4 are combined to obtain a filter having a frequency response depicted in FIG. 7.

In the above formula (1), s denotes a Laplace operator, m denotes a number of a mode of disk flutter, and ζ₁ᵢ, ω₁ᵢ, ζ₂ᵢ, ω₂ᵢ denote damping coefficients and natural angular frequencies, which are design parameters.

In an example described below, flutter components are numbered in sequence from a mode of a lower frequency band.

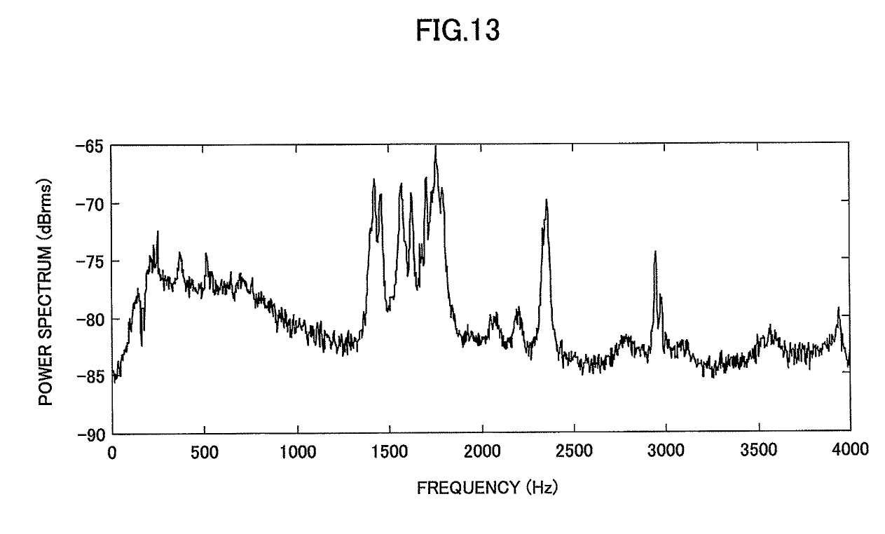

In step S1 of FIG. 11, from a measurement result (i.e., for example, a spectrum depicted in FIG. 13, the same as that shown in FIG. 8) of a position error signal (which may be simply referred to as PES, hereinafter) for each magnetic disk, a flutter frequency of the magnetic disk has is obtained.

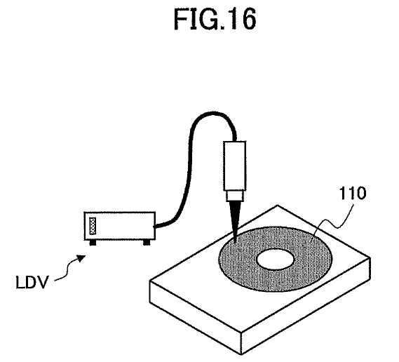

As will be described later with reference to FIG. 16, it is also possible to obtain a flutter frequency of disk flutter which the magnetic disk has from a spectrum of a vertical vibration of the magnetic disk measured with the use of a laser Doppler vibrometer (LDV).

Next, in step S2, in order to obtain a transfer function of a filter for each flutter frequency, natural angular frequencies ω₁ᵢ, ω₂ᵢ are determined around a maximum value and a minimum value of a frequency range of each flutter component, respectively. Further, by adjusting the dumping coefficients ζ₁ᵢ, ζ₂ᵢ, a peak amount of a gain which the filter has is determined.

The respective parameters of the filter are determined in such a manner that, in a PES spectrum, in order to suppress an influence of a disturbance (i.e., a vibration not directly relevant to disk flutter) which a vibration sensor also detects, the filter should have a frequency response covering the frequency range of the flutter frequency to the minimum existent, while gain and phase requirements, described below, the FF controller should satisfy should be met. The gain and phase requirements which the FF controller should satisfy are gain and phase requirements of the FF controller such that the flutter component is minimum finally.

In step S3, the values of ζ and ω are adjusted so that the gain and phase requirements can be satisfied so as to suppress the flutter component. Steps S1, S2 and S3 are repeated m times (steps S4, S5).

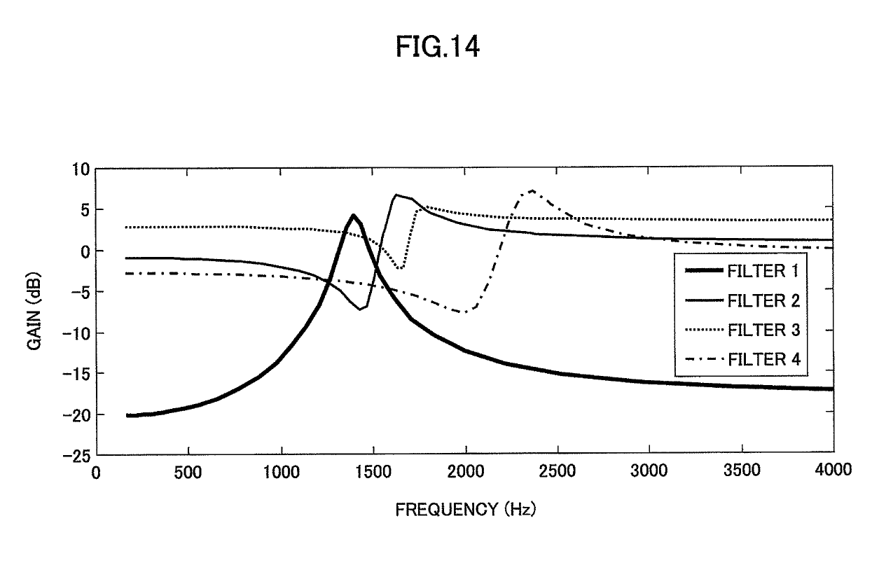

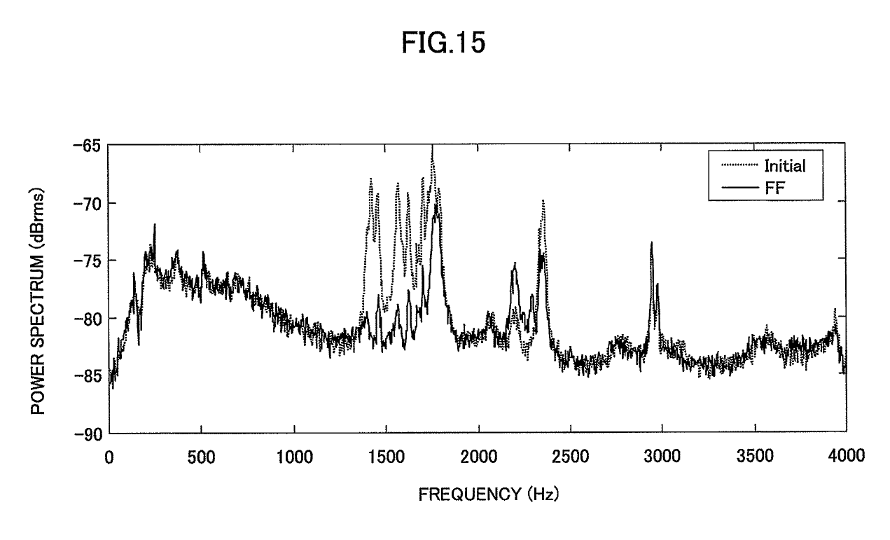

FIG. 12 depicts an example of a frequency response of the FF controller where m=4. FIG. 14 depicts a frequency response (the same as those of FIG. 10, (a)) of corresponding four frequency filters (i.e., a filter 1, a filter 2, a filter 3 and a filter 4) which the FF controller having the frequency response of FIG. 12 (the same as those of FIG. 10, (b)) has. FIG. 15 depicts an advantage of the FF controller. In FIG. 15, a broken line represents a spectrum of PES depicted in FIG. 3, and a solid line represents a spectrum of PES improved by a function of the FF controller.

A specific method of determining the above-mentioned frequency range of a flutter component in step S2 of FIG. 11 will now be described. When no other peaks occur around the flutter component in a given PES spectrum, a frequency range around a peak of the flutter component in which range a gain variation is small is determined as a frequency range of the flutter component. When other peaks occur around the flutter component in a given PES spectrum, a frequency at which a gain is minimum between the other peak and the peak of the flutter component is obtained, each before and after the peak of the flutter component. Then a frequency range between the thus-obtained frequencies at each of which the gain is thus minimum before and after the peak of the flutter component is obtained as a frequency range of the flutter component.

It is noted that the steps depicted in FIG. 11 will be described later more specifically.

Next, a method of absorbing individual difference caused by difference in the head number, in the method of designing a FF controller, will be described.

As mentioned above, because the vibration sensor is mounted on the suspension or arm on which the magnetic head is mounted, the vibration sensor may detect a mode of vibration of the suspension or the arm other than a vibration caused by disk flutter. Therefore, as a result of a gain of the FF controller being reduced for a frequency of the mode of vibration of the suspension or the arm, an influence of the mode of vibration of the suspension or the arm, which varies depending on each particular head number, is eliminated.

That is, because the mode of vibration of the suspension or the arm varies depending on the head number, it would be necessary to adjust the FF controller for each magnetic head, if strict adjustment were carried out. However, instead, as a result of the FF controller having a frequency response such as that depicted in FIG. 12, where a gain of the FF controller is reduced for frequencies other than frequencies corresponding to the flutter components, it is possible to eliminate an influence of the mode of vibration of the suspension or the arm, which varies depending on each particular head number.

Further, by providing the FF controller for each magnetic disk as described above with reference to FIG. 4, it is also possible to eliminate an influence of individual difference (i.e., difference in a manner in which a mode of disk flutter occurs) of each magnetic disk in the magnetic disk drive having the plurality of magnetic disks.

Further, as to an effect of eliminating an influence of disk flutter on magnetic disk positioning control, for a case where, in a magnetic disk drive having the plurality of magnetic disks, a flutter frequency does not vary depending on each particular magnetic disk, only a single common vibration sensor may be provided in the magnetic disk drive instead of providing the vibration sensor for each magnetic disk, as described above with reference to FIG. 6. Thereby, it is possible to achieve magnetic head positioning control without actually degrading performance of eliminating an influence of disk flutter.

FIG. 16 illustrates a method of rotating the magnetic disk, measuring a vibration of the magnetic head with the use of the above-mentioned vibration sensor, and in addition, a laser Doppler vibrometer (LDV), which is separately prepared.

Thus, a flutter frequency of the magnetic disk (i.e., a mode of disk flutter) is obtained from a PES spectrum and outputs of the vibration sensor and the laser Doppler vibrometer (LDV) in the magnetic disk drive. This method corresponds to the above-mentioned step S1 of FIG. 11.

As depicted in FIG. 16, the laser Doppler vibrometer is used to directly measure a vertical vibration of the magnetic disk, in the magnetic disk drive mounting the FF controller described above with reference to FIG. 2. Then, a spectrum of a measurement result obtained from the laser Doppler vibrometer is compared with PES or a spectrum of an output of the vibration sensor, and thus, it is determined which peak in each spectrum corresponds to disk flutter.

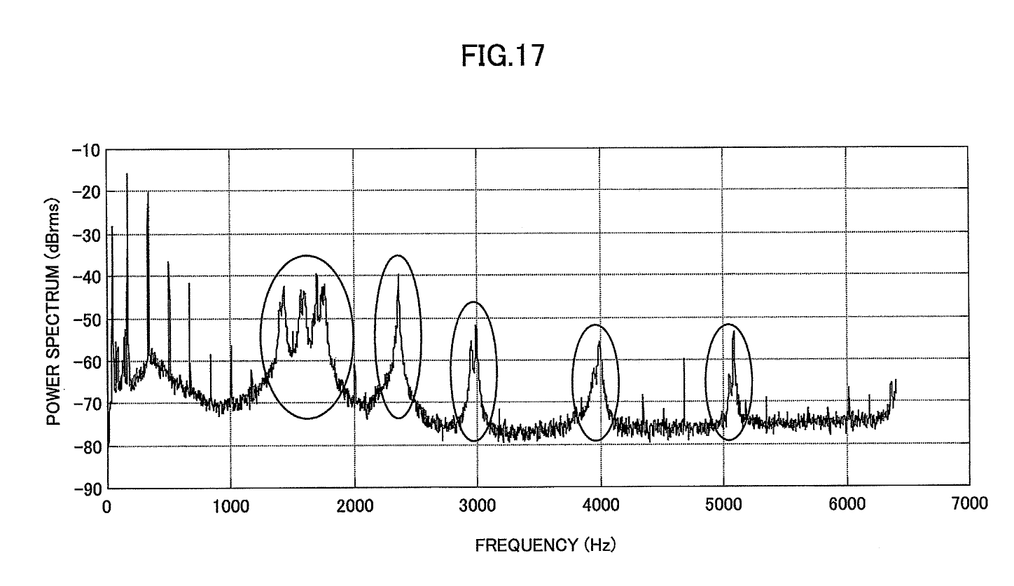

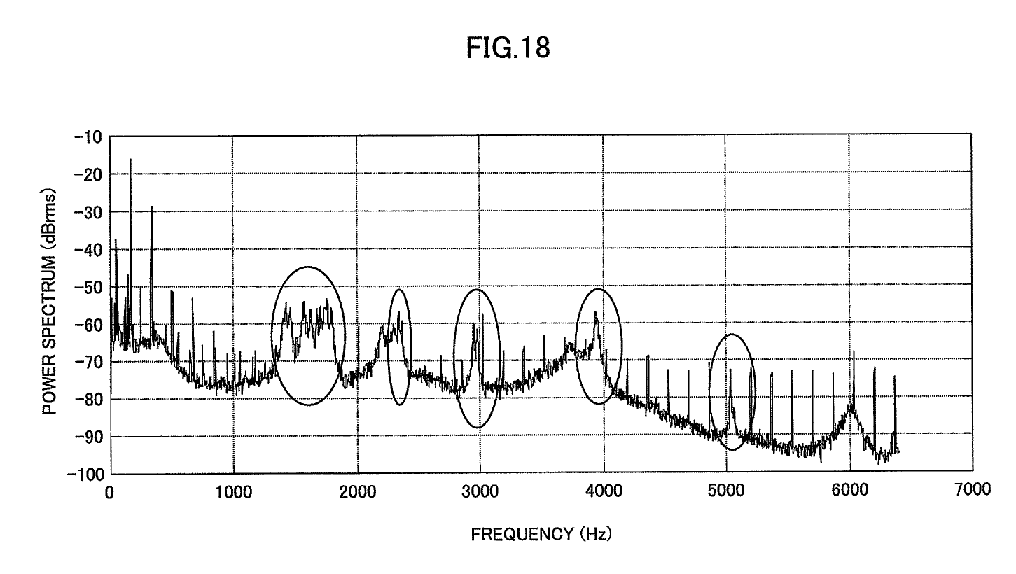

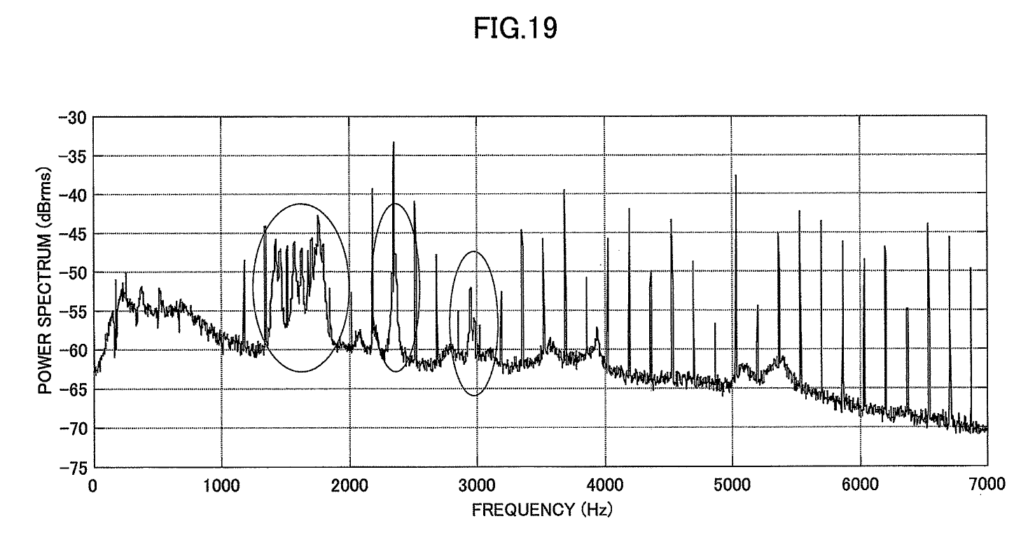

FIG. 17 depicts the measurement result of the laser Doppler vibrometer. It can be seen that, in FIG. 17, frequency parts defined by five ellipses represent vibrations cased by disk flutter. As a result, it can be seen that, frequency parts defined by five ellipses in FIG. 18 depicting the output of the vibration sensor also represent vibrations caused by disk flutter. Similarly, it can be seen that, frequency parts defined by three ellipses in FIG. 19 depicting the PES also represent position errors caused by disk flutter.

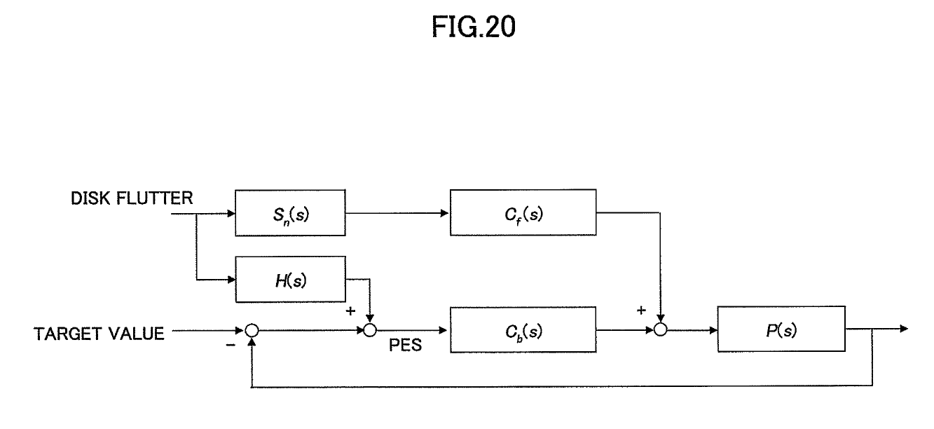

FIG. 20 is a block diagram of a part of the control system depicted in FIG. 4. Such a configuration as that shown in FIG. 20 is, for example, discussed in the above-mentioned fifth patent document.

In FIG. 20, P(s) corresponds to the voice coil motor 160 depicted in FIG. 4, C_{b}(s) corresponds to the FB controller 20, Sₙ(s) corresponds to the vibration sensor 50, and H(s) which is a transfer function from disk flutter to PES corresponds to an influence of disk flutter on PES. C_{f}(s) corresponds to the FF controller 10.

In FIG. 20, PES is obtained as a result of a position signal of the magnetic head 130 being compared with a given target value. In this case, PES includes an influence of disk flutter. In order to eliminate the influence of disk flutter, the disk flutter is detected by the vibration sensor, and a control amount is generated by the FF controller 10 based on a detection value of the vibration sensor. The control amount is then added to an output of the FB controller 20, and thereby, a control amount considering the influence of disk flutter is provided to the voice coil motor 160. As a result, it is possible to effectively improve precision in magnetic head positioning control with the use of voice coil motor 160.

In the control system depicted in FIG. 20, such control is carried out that C_{f} (s) cancels a disturbance which is included in PES from disk flutter through H(s). In this case, theoretically speaking, the FF controller C_{f}(s) is expressed by the following transfer function of formula (2):

C_{f}(s)=P(s)⁻¹H(s)Sₙ(s)⁻¹ (2)

However, an unknown element such as H(s) is included, and also, the degree in the FF controller is limited. Therefore, the above-mentioned formula (2), as it is, cannot be realized in the FF controller. Specifically, as will be described later, the FF controller is such that a gain and a phase of the FF controller with which a flutter component is minimum are obtained, and the FF controller satisfies thus-obtained gain and phase requirements.

FIG. 21 depicts how disk flutter has an influence on PES. This matter is also discussed in the above-mentioned fifth patent document and the above-mentioned second non-patent document, for example. In FIG. 21, broken lines represent a state before the magnetic disk 110 is curved because of disk flutter yet. Solid lines represent a state after the magnetic disk 110 is curved because of disk flutter. In FIG. 21, it is assumed that, before the magnetic disk 110 is thus curved, a center line (represented by a vertical broken line) of the magnetic head 130 agrees with a track center (represented by a white circle) on the magnetic disk 110. After the magnetic disk 110 is thus curved, it can be seen that, with respect to the center line (represented by a vertical solid line) of the magnetic head 130, the track center (represented by a black circle) on the magnetic disk 110 is shifted in an outer radius direction of the magnetic disk 110. This shift is detectable as PES with the use of the magnetic head 130.

Next, a specific method of adjusting the second order filter for each flutter frequency included in the FF controller will be described.

This method corresponds to the above-mentioned method of adjusting characteristics of the second order filter in steps S2 or S3 of FIG. 11.

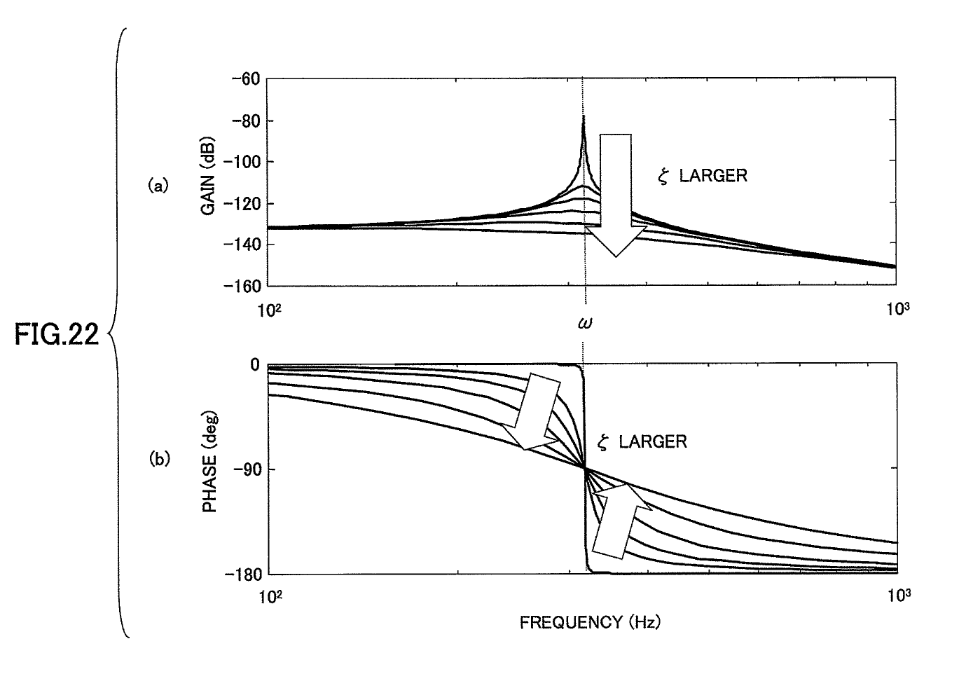

Generally speaking, a second order filter has a frequency response such as that depicted in FIG. 22 represented by the following formula (3)

$$\frac{1}{{s}^{2} + 2 Ϛω s + {ω}^{2}} \qquad ( 3 )$$

In the formula (3), ω denotes a natural angular frequency and is a parameter concerning a frequency at which a gain has a peak and a frequency at which a phase has a value of −90°. ζ denotes a damping coefficient, and a parameter concerning a height and a width of a peak of a gain, and how a phase delays. In FIG. 22, when ω changes, the frequency response shifts left or right in parallel accordingly. In FIG. 22, when ζ changes, the frequency response shifts in a direction indicated by arrows depicted in FIG. 21 accordingly.

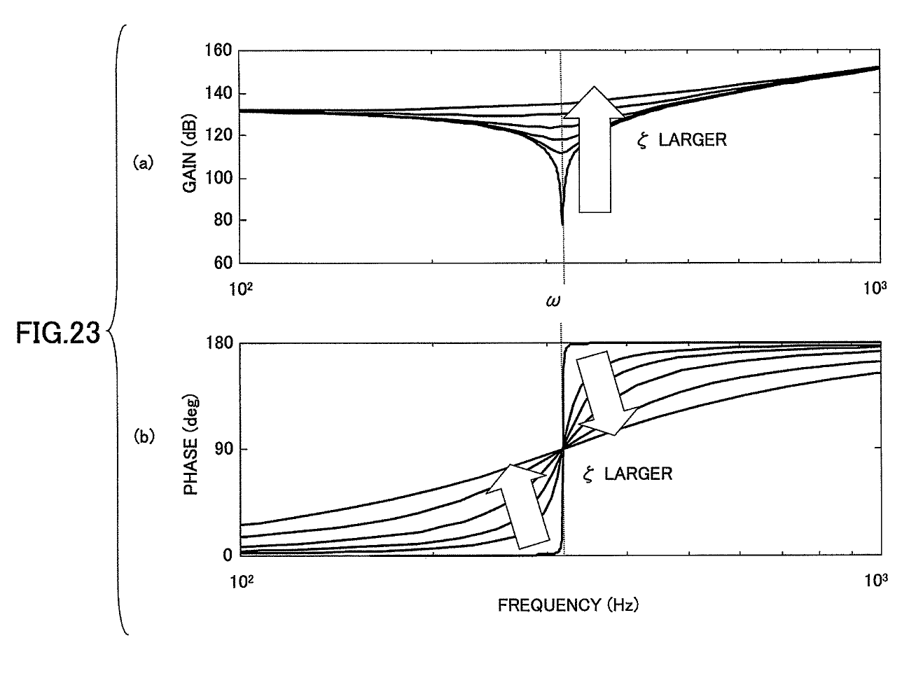

Further, a second order filter represented by the following formula (4) has a frequency response as that depicted in FIG. 23:

s²+2ζωs+ω² (4)

Gain characteristics depicted in FIG. 23, (a) are obtained as a result of, gain characteristics depicted in FIG. 22, (a) being folded back with respect to a line of 0 dB. Phase characteristics depicted in FIG. 23, (b) are obtained as a result of, phase characteristics depicted in FIG. 22, (b) being folded back with respect to a line of 0°. In a Bode diagram, multiplication between transfer functions is expressed as the transfer functions are added together. Therefore, a frequency response of a second order filter expressed by the following formula (5):

$$\frac{{s}^{2} + 2 {Ϛ}_{2} {ω}_{2} s + {ω}_{2}^{2}}{{s}^{2} + 2 {Ϛ}_{1} {ω}_{1} s + {ω}_{1}^{2}} \qquad ( 5 )$$

are that obtained as a result of the frequency response of FIG. 22 and the frequency response of FIG. 23 being added together. It is noted that the formula (5) is obtained as a result of the above-mentioned formula (3) where ζ and ω are replaced by ζ₁ and ω₁ and the above-mentioned formula (4) where ζ and ω are replaced by ζ₂ and ω₂ being multiplied together.

As a result of the above-mentioned second order filter for each flutter frequency being designed to act as the second order filter expressed by the formula (5), a frequency response of the second order filter for each flutter frequency included in the FF controller such as those shown in FIG. 14 can be obtained, where the respective parameters ω₁, ω₂, ζ₁, ζ₂ are adjusted appropriately.

Next, a method of obtaining such a gain and a phase of the FF controller that the above-mentioned flutter component is minimum will be described.

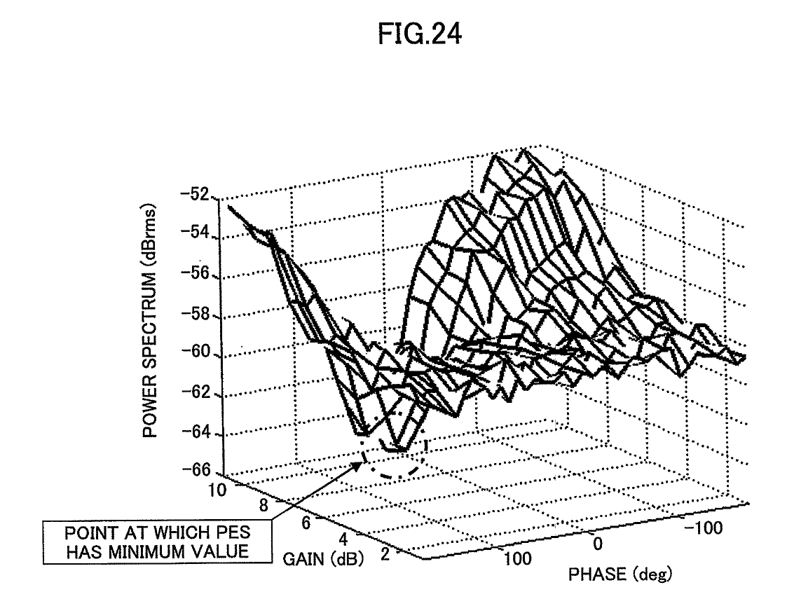

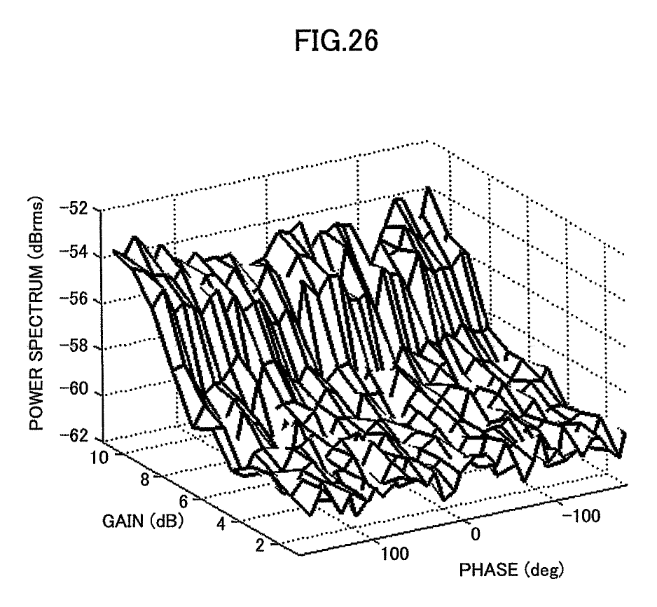

First, as the FF controller C_{f}(s) of FIG. 20, a filter for which a gain and a phase are adjustable is prepared. Then, PES is measured with the gain and phase of the filter being changed in the system of FIG. 20. From a result thereof, gain, phase and PES spectra are plotted where x-axis represents a gain, y-axis represents a phase and z-axis represents PES, and thus, three-dimensional plots of FIGS. 24 and 26 are obtained.

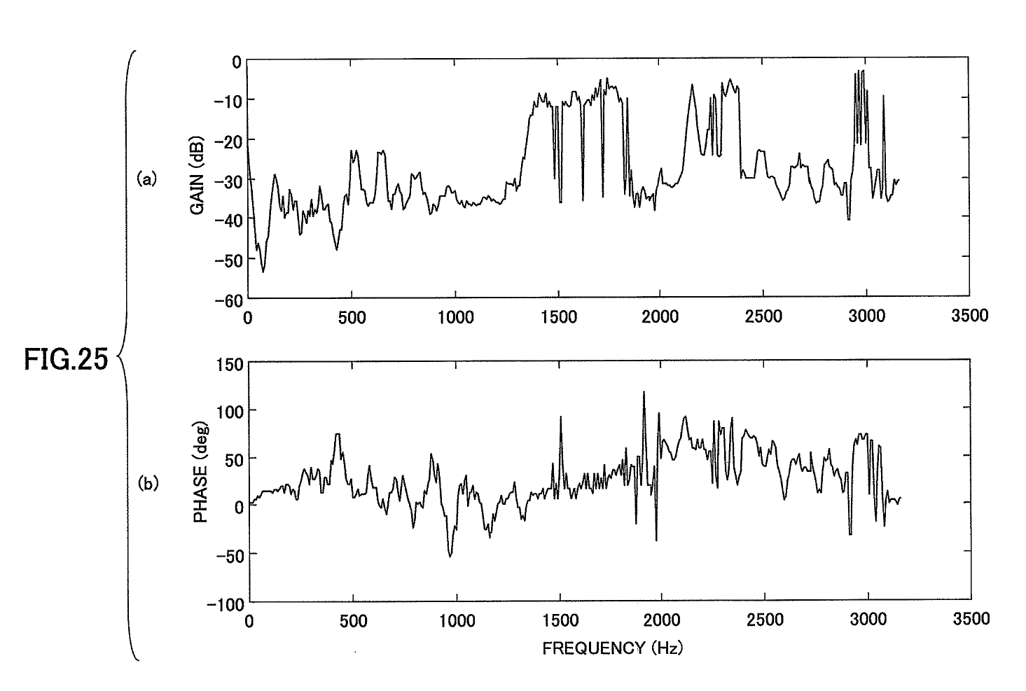

From the three-dimensional plots, such requirements of a gain and a phase that the PES spectrum is minimum are obtained. In an example of FIG. 24, a part defined by a circle of an alternate long and short dash line satisfies the requirements. That is, as depicted in FIG. 24, it can be seen that, this part has PES which is smaller than the other parts. This point at which PES is minimum is obtained for all the frequencies, corresponding gain and phase are plotted where abscissa represents a frequency, and as a result, a frequency response of FIG. 25 is obtained.

As a result of the FF controller having the frequency response of FIG. 25, such a FF controller that PES is minimum for all the frequencies is obtained. However, first, actually, it is difficult to realize the controller having the frequency response of FIG. 25. Second, for frequencies other than flutter frequencies, as shown in FIG. 26, although a minimum value of PES occurs, a part of a certain condition at which PES is smaller in comparison with to the other condition does not occur, because of property that there is no correlation between an output of the vibration sensor and PES. That is, the gain and phase requirements of FIG. 25 should not necessarily be satisfied. Although the gain and phase requirements of FIG. 25 are deviated from, PES does not change much unless the control system enters a condition of degrading PES. Therefore, importance of such gain and phase requirements is low for a frequency other than the flutter frequency, in comparison to importance of such gain and phase requirements for the flutter frequencies. By the above-mentioned two reasons, in the embodiment, the FF controller satisfies the gain and phase requirements of FIG. 25 especially for the flutter frequencies.

It is noted that, in the above-described method of obtaining the gain and phase requirements, PES is measured with a gain and a phase of the FF controller being changed, and, from the measurement results, gain and phase requirements at which PES is minimum are determined as the gain and phase requirements. In this method, the following requirements of PES may be set by a designer. That is, as the gain and phase requirements, for each frequency, such a range of a gain and a phase are determined that, in the range of a gain and a phase, PES is lower by ‘a’ dB than that in a case where no FF control is carried out. Alternatively, as the gain and phase requirements, for each frequency, such a range of a gain and a phase are determined that, in the range of a gain and a phase, a difference between a value of PES and a minimum value of PES is within ‘b’ dB. Thereby, the gain and phase requirements may be obtained as a range instead of as a point.

In this case, in step S3 of FIG. 11, when a gain and a phase of the FF controller fall within such a range of PES which is thus set by the designer, it is determined that the gain and phase requirements of the FF controller as if the flutter component is minimum are met.

A method of obtaining a frequency response will now be described in more detail.

In the embodiment, as depicted by the above-mentioned formula (1), the FF controller includes m single second order filters connected in series. More specifically, in the embodiment, m=4, and thus, the filters 1, 2, 3 and 4 are connected in series, to obtain a filter having a frequency response shown in FIG. 7, as mentioned above.

The following operator (6) included in the formula (1):

$${\prod }_{i = 1}^{m} \qquad ( 6 )$$

is used to express operation depicted by the following formula (7):

$${\prod }_{i = 1}^{m} {a}_{i} = {a}_{1} \times … \times {a}_{m} \qquad ( 7 )$$

As shown in the formula (7), the above-mentioned operator (6) is used to multiply a₁, a₂, a₃, . . . , aₘ together. When m filters are connected in series, a transfer function of a combined filter obtained from the series connection of the m filters can be obtained from multiplying respective transfer functions of the m filters. Therefore, by using the above-mentioned operator, the formula (1) depicts a transfer function of a combined filter obtained from respective single second order filters each having a transfer function as depicted in the formula (5) being connected in series. In the embodiment, m=4, as mentioned above, and thus, the four single second order filters 1, 2, 3 and 4 are connected in series, and a combined filter obtained from the series connection of the respective four single second order filters 1, 2, 3 and 4 has a transfer function obtained from respective transfer functions of the respective single second order filters 1, 2, 3 and 4 being multiplied together. The combined filter has the frequency response of FIG. 7 as mentioned above as a result of the four single second order filters 1, 2, 3 and 4 being thus connected in series and thus, being combined together.

A frequency response of each single second order filter included in the FF controller may be obtained from a frequency response of the second order filter described above with reference to FIGS. 22 and 23. How specifically a frequency response of the second order filter moves as the respective parameters ζₙᵢ and ωₙᵢ are changed has been described above with reference to FIGS. 22 and 23.

The parameters ζₙᵢ and ωₙᵢ of each second order filter are adjusted in such a manner that a gain has a peak at a corresponding flutter frequency, and also, the gain and phase requirements of the FF controller such that the corresponding flutter component is minimum are met.

A specific procedure of designing the FF controller is depicted in FIG. 11 which has been described above. First, as described above with reference to FIGS. 16 through 19, based on actually measured values, an i-th flutter frequency (i=1, 2, . . . , m) is obtained (step S1 of FIG. 11). It is noted that, as can bee seen from comparison between the above-mentioned formulas (1) and (5), the respective parameters ω₁ᵢ, ω₂ᵢ, ζ₁ᵢ, ζ₂ᵢ used in the formula (1) correspond to the respective parameters ω₁, ω₂, ζ₁, ζ₂ used in the formula (5) for the i-th filter or i-th flutter frequency.

Next, for the thus-obtained i-th flutter frequency, parameters ω₁ᵢ, ω₂ᵢ are set, and in consideration of a PES spectrum, parameters ζ₁ᵢ, ζ₂ᵢ are obtained in step S2.

Then, the respective parameters ω₁ᵢ, ω₂ᵢ, ζ₁ᵢ, ζ₂ᵢ are adjusted, in consideration of a frequency response of a filter obtained as a result of filters up to the (i−1)-th filter being combined together, as well as the gain and phase characteristics of FIG. 25. Then, finally, ω₁ₖ, ω₂ₖ, ζ₁ₖ, ζ₂ₖ where k=1, 2, . . . , i are finely adjusted in such a manner that a frequency response of a filter obtained as a result of filters up to the i-th filter being combined together satisfy the gain and phase requirements of FIG. 25 especially for the flutter frequencies. That is, when the gain and phase requirements of FIG. 25 especially for the flutter frequencies are agreed with by the frequency response of the filter obtained as a result of filters up to the i-th filter being combined together, the frequency responses of the 1 through i-th filters are adjusted so that the frequency response of the filter obtained as a result of filters up to the i-th filter being combined together agree with the gain and phase requirements of FIG. 25 especially for the flutter frequencies. Then, i is updated, and steps S1, S2 and S3 are repeated, until i=m.

In the FF controller in the embodiment, m=4, and an influence of disk flutter is effectively suppressed at a peak of 1.4 kHz through 1.8 kHz and a peak of 2.35 kHz, as depicted in FIG. 12.

What is claimed is:

1. A designing method for a feedforward controller for controlling a position of a magnetic head in a magnetic disk drive, said method comprising:
a measuring step of measuring a vibration of the magnetic head in a state in which a magnetic disk is rotated in the magnetic disk drive,
a flutter frequency specifying step of obtaining, from a spectrum of a measured vibration, a flutter frequency which is a frequency of a vibration caused by the magnetic disk fluttering,
a filter designing step of designing a filter for each flutter frequency having a peak of a gain for a respective one of obtained flutter frequencies, and
a step of obtaining a feedforward controller for controlling a position of the magnetic head by combining filters designed for the respective flutter frequencies.

2. The designing method for a feedforward controller for controlling a position of a magnetic head in a magnetic disk drive as claimed in claim 1, wherein:
the designing step comprises:
a filter characteristic determining step of obtaining a frequency response of a corresponding i-th filter such that the i-th filter has a peak of a gain for an i-th flutter frequency, where i has each number in a range of 1 through m, from among m flutter frequencies obtained in the filter frequency specifying step,
a combined frequency response calculating step of obtaining a frequency response from combining 1 though i-th filters,
a requirement determining step of determining whether the frequency response obtained from combining the 1 through i-th filters satisfies a predetermined requirement obtained for a frequency response of the feedforward controller, for 1 through i-th flutter frequencies,
a filter characteristic adjusting step of adjusting, when the requirement determining step has determined the predetermined requirement is not satisfied, frequency responses of the 1 through i-th filters so that the frequency response obtained from combining the 1 through i-th filters satisfies the predetermined requirement, wherein:
the filter characteristic determining step, the combined frequency response calculating step, the requirement determining step and the filter characteristic adjusting step are carried out in sequence for each of the respective filters of the 1 through m-th flutter frequencies.

3. The designing method for a feedforward controller for controlling a position of a magnetic head on a magnetic disk drive as claimed in claim 2, wherein:
the predetermined requirement obtained for a frequency response of the feedforward controller comprises such a gain and a phase of the feedforward controller that a position error amount of the magnetic head is minimum, wherein such a gain and a phase of the feedforward controller that a position error amount of the magnetic head is minimum are obtained as a result of a position error of the magnetic head being measured with a gain and a phase of the feedforward controller being changed gradually in a state in which the feedforward controller is incorporated in the magnetic disk drive.

4. The designing method for a feedforward controller for controlling a position of a magnetic head in a magnetic disk drive as claimed in claim 2, wherein:
a transfer function of the feedforward controller is expressed by the following formula (1):
$$C ( s ) = {\prod }_{i = 1}^{m} \frac{{s}^{2} + 2 {Ϛ}_{2 i} {ω}_{2 i} s + {ω}_{2 i}^{2}}{{s}^{2} + 2 {Ϛ}_{1 i} {ω}_{1 i} s + {ω}_{1 i}^{2}} \qquad ( 1 )$$
wherein:
in the filter characteristic determining step or the filter characteristic adjusting step, respective values of ζ₁ᵢ, ω₁ᵢ, ζ₂ᵢ, ζ₂ᵢ, determining the frequency response of the i-th filter (where i is each number in a range of 1 through m), are determined or adjusted.

5. A magnetic disk drive comprising:
a feedforward controller for controlling a position of a magnetic head, designed as a result of carrying out:
a measuring step of measuring a vibration of the magnetic head in a state in which a magnetic disk is rotated in the magnetic disk drive,
a flutter frequency specifying step of obtaining, from a spectrum of a measured vibration, a flutter frequency which is a frequency of a vibration caused by the magnetic disk fluttering,
a filter designing step of designing a filter for each flutter frequency having a peak of a gain at a respective one of obtained flutter frequencies, and
a step of obtaining a feedforward controller for controlling a position of the magnetic head by combining filters designed for the respective flutter frequencies.

6. The magnetic disk drive as claimed in claim 5, wherein:
the feedforward controller is provided for each magnetic disk.

7. The magnetic disk drive as claimed in claim 6, wherein:
a sensor providing a measurement value of a disk flutter amount to the feedforward controller is provided, for each magnetic disk, to any suspension or arm of suspensions and arms supporting magnetic heads which sandwich the magnetic disk.

8. The magnetic disk drive as claimed in claim 7, wherein:
the suspension or arm to which the sensor is provided has, for each magnetic disk, the same positional relationship with respect to the corresponding magnetic disk.

9. The magnetic disk drive as claimed in claim 6, wherein:
with respect to control of a position of the magnetic head having the sensor provided to the corresponding suspension or arm, a sign of an output of the sensor is inverted in control of a position of the magnetic head which is one not having the sensor provided to the corresponding suspension or arm.

10. The magnetic disk drive as claimed in claim 5, wherein:
a sensor providing a measurement value of a disk flutter amount to the feedforward controller is provided to any suspension or arm of suspensions and arms supporting the magnetic heads which sandwich the respective ones of all the magnetic disks included in the magnetic disk drive.

11. The magnetic disk drive as claimed in claim 10, wherein:
in control of a position of the magnetic head having an opposite positional relationship with respect to the corresponding magnetic disk to a positional relationship with respect to the corresponding magnetic disk of the magnetic head for which the sensor is provided, a sign of an output of the sensor to be used to the control is inverted.

12. A feedforward controller for controlling a position of a magnetic head in a magnetic disk drive, designed as a result of carrying out:
a measuring step of measuring a vibration of the magnetic head in a state in which a magnetic disk is rotated in the magnetic disk drive,
a flutter frequency specifying step of obtaining, from a spectrum of a measured vibration, a flutter frequency which is a frequency of a vibration caused by the magnetic disk fluttering,
a filter designing step of designing a filter for each flutter frequency having a peak of a gain at a respective one of obtained flutter frequencies, and
a step of obtaining a feedforward controller for controlling a position of the magnetic head by combining filters designed for the respective flutter frequencies.

13. The feedforward controller for controlling a position of a magnetic head in a magnetic disk drive as claimed in claim 12, wherein:
the designing step comprises:
a filter characteristic determining step of obtaining a frequency response of a corresponding i-th filter such that the i-th filter has a peak of a gain at an i-th flutter frequency, where i has each number in a range of 1 through m, from among m flutter frequencies obtained in the filter frequency specifying step,
a combined frequency response calculating step of obtaining a frequency response obtained from combining 1 though i-th filters,
a requirement determining step of determining whether the frequency response obtained from combining the 1 through i-th filters satisfy a predetermined requirement obtained for a frequency response of the feedforward controller, for 1 through i-th flutter frequencies,
a filter characteristic adjusting step of adjusting, when the requirement determining step has determined the predetermined requirement is not satisfied, frequency responses of the 1 through i-th filters so that the frequency response obtained from combining the 1 through i-th filters satisfies the predetermined requirement, wherein:
in the designing step, the filter characteristic determining step, the combined frequency response calculating step, the requirement determining step and the filter characteristic adjusting step are carried out in sequence for each of the filters of the 1 through m-th flutter frequencies.

14. The feedforward controller for controlling a position of a magnetic head on a magnetic disk drive as claimed claim 13, wherein:
the predetermined requirement obtained for a frequency response of the feedforward controller comprises such a gain and a phase of the feedforward controller that a position error amount of the magnetic head is minimum, wherein such a gain and a phase of the feedforward controller that a position error amount of the magnetic head is minimum are obtained as a result of a position error of the magnetic head being measured with a gain and a phase of the feedforward controller being changed gradually in a state in which the feedforward controller is incorporated in the magnetic disk drive.

15. The feedforward controller for controlling a position of a magnetic head in a magnetic disk drive as claimed in claim 13, wherein:
a transfer function of the feedforward controller is expressed by the following formula (1):
$$C ( s ) = {\prod }_{i = 1}^{m} \frac{{s}^{2} + 2 {Ϛ}_{2 i} {ω}_{2 i} s + {ω}_{2 i}^{2}}{{s}^{2} + 2 {Ϛ}_{1 i} {ω}_{1 i} s + {ω}_{1 i}^{2}} \qquad ( 1 )$$
wherein:
in the filter characteristic determining step or the filter characteristic adjusting step, respective values of ζ₁ᵢ, ω₁ᵢ, ζ₂ᵢ, ω₂ᵢ, determining frequency response of the i-th filter (where i is each number in a range of 1 through m), are determined or adjusted.
